(19) United States
(12) Patent Application Publication
(10) Pub. No.: US 2012/0033048 A1
(43) Pub. Date: Feb. 9, 2012

(54) 3D IMAGE DISPLAY APPARATUS, 3D IMAGE PLAYBACK APPARATUS, AND 3D IMAGE VIEWING SYSTEM

(75) Inventors: Suguru OGAWA, Osaka (JP); Isamu Ishimura, Kyoto (JP)

(73) Assignee: PANASONIC CORPORATION, Osaka (JP)

(21) Appl. No.: 13/277,015

(22) Filed: Oct. 19, 2011

Related U.S. Application Data
(63) Continuation of application No. PCT/JP2010/001837, filed on Mar. 15, 2010.

(30) Foreign Application Priority Data
Apr. 22, 2009 (JP) 2009-104015

(51) Int. Cl. H04N 13/02; H04N 13/04

(52) U.S. Cl. 348/46; 348/56; 348/E13.026; 348/E13.074

(57) ABSTRACT

A 3D image display apparatus comprises a transmission-reception device and a control signal output device. The transmission-reception device receives a video data including a plurality of image informations which is base data of 3D images from a 3D image playback apparatus through a transmission cable and thereby generates an image signal. The control signal output device transmits a control signal for controlling light penetration states of penetration units for right and left eyes to shutter glasses. The transmission-reception device receives the video data from the 3D image playback apparatus through the transmission cable and thereby generates the image signal and a synchronizing signal. The synchronizing signal indicates which of the plurality of image informations is included in the image signal currently outputted. The control signal output device generates the control signal based on the synchronizing signal.

### FIELD OF THE INVENTION

The present invention relates to a 3D image display apparatus, a 3D image playback apparatus, and a 3D image viewing system, more particularly to a technology for simplifying a transmission cable routed to transmit video data, which is the base data of 3D images, from a plurality of video cameras.

### BACKGROUND OF THE INVENTION

A 3D image viewing system enables to recognize 3D images by using binocular parallax information (information of disparity between images recognized with right and left eyes).

### PRIOR ART DOCUMENT

### Patent Document

Patent Document 1: Unexamined Japanese Patent Applications Laid-Open No. 11-341518

### SUMMARY OF THE INVENTION

### Problem to be Solved by the Invention

A technical disadvantage of the systems conventionally available is a wiring complexity because different transmission cables are used to wire a plurality of video cameras provided to capture images through different angles so that image information, which is the base data of 3D images, is obtained.

According to the invention disclosed in Patent Document 1, a display device is placed horizontally so that a viewer can enjoy 3D images regardless of his positional relationship with the display device horizontally placed (regular position, position opposite to the regular position, or positions on lateral sides of the regular position). However, these systems still have the conventional problem of a wiring complexity resulting from multiple transmission cables.

The present invention was accomplished to solve the conventional problem, and a main object thereof is to simplify a transmission cable routed to transmit video data, which is the base data of 3D images, from a plurality of video cameras.

### Means for Solving the Problem

To solve the conventional problem, the present invention provides a 3D image display apparatus, a 3D image playback apparatus, a 3D image viewing system configured as described below.

A 3D image display apparatus according to the present invention comprises:

a transmission-reception device configured to receive a video data which is base data of 3D images including a plurality of image informations from a 3D image playback apparatus through a transmission cable and generate an image signal based on the video data;

a display device configured to display thereon an image obtained from the image signal; and

a control signal output device configured to output a control signal to shutter glasses worn by a viewer of the display device, the control signal controlling light-penetration states in penetration units for both eyes provided in the shutter glasses, wherein

the transmission-reception device receives the video data from the 3D image playback apparatus through the single transmission cable and generates the image signal and a synchronizing signal based on the received video data, the synchronizing signal indicating which of the plurality of image informations is included in the image signal currently outputted, and

the control signal output device generates the control signal based on the synchronizing signal.

In the 3D image display apparatus thus configured, a single transmission cable is provided and connected to the transmission-reception device of the 3D image display apparatus, therefore, the transmission cable can be readily routed without any wiring complexity. Further, the apparatus can still display 3D images all the same when the viewer's posture wearing the shutter glasses is off balance.

### Effect of the Invention

According to the present invention, wherein the 3D image display apparatus and the 3D image playback apparatus are connected to each other with a transmission cable, the transmission cable can be readily routed without any wiring complexity.

### BRIEF DESCRIPTION OF THE DRAWINGS

FIG. 1 is a block diagram illustrating an overall structure of a 3D image viewing system according to an exemplary embodiment 1 of the present invention.

FIG. 2 is a flow chart of processing steps by a reception device according to the exemplary embodiment 1.

FIG. 3 is a block diagram illustrating an overall structure of a 3D image viewing system according to an exemplary embodiment 2 of the present invention.

FIG. 4 is a correlative table of image informations of a plurality of positions and a viewing posture information, illustrating how a control signal inputted to shutter glasses is defined in the 3D image viewing system according to the exemplary embodiment 2.

FIG. 5 is a correlative table of the viewing posture information indicating viewers' viewing postures and the image informations to be suitably selected for the respective postures in a playback-side transmission-reception device according to the exemplary embodiment 2.

FIG. 6 is a perspective view of an image pickup device of a conventional 3D image viewing system.

FIG. 7 is an illustration of an image display device of the conventional 3D image viewing system and examples of a viewer's viewing posture.

FIG. 8 is a block diagram illustrating an overall structure of the conventional 3D image viewing system.

FIG. 9 is a correlative table of viewing posture informations and image informations of a plurality of positions, illustrating how a control signal inputted to shutter glasses is defined in the conventional 3D image viewing system.

### EXEMPLARY EMBODIMENTS FOR CARRYING OUT THE INVENTION

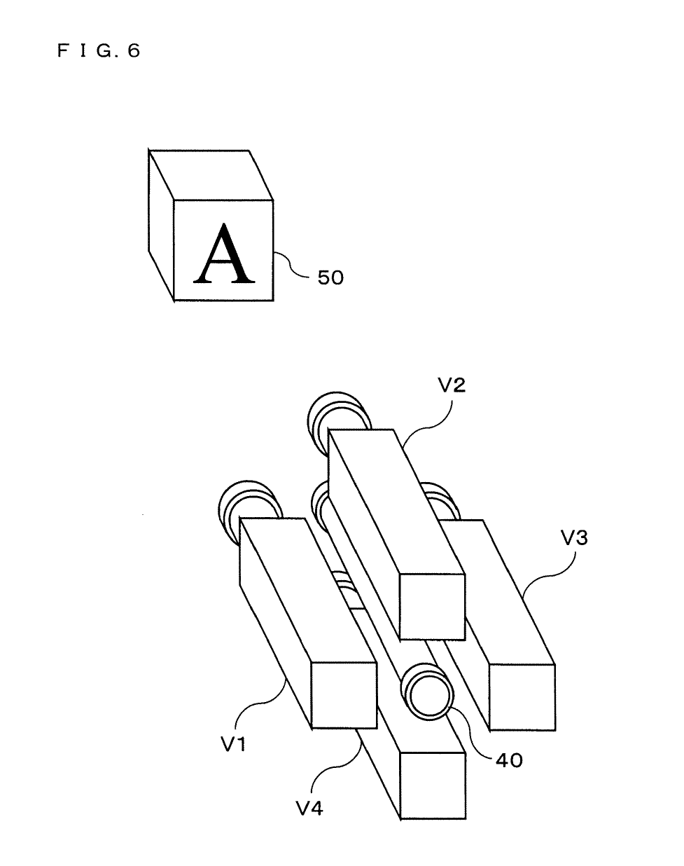

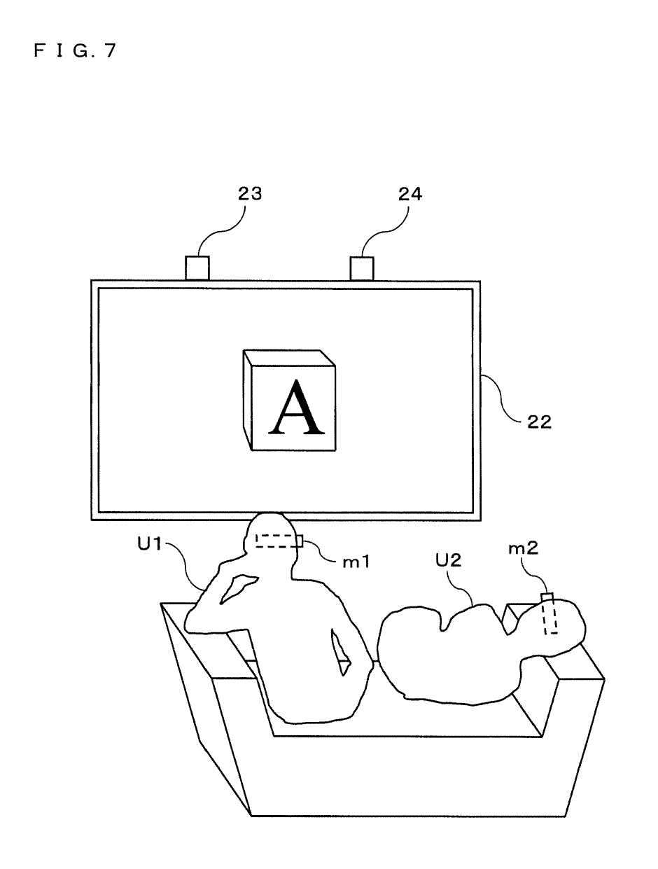

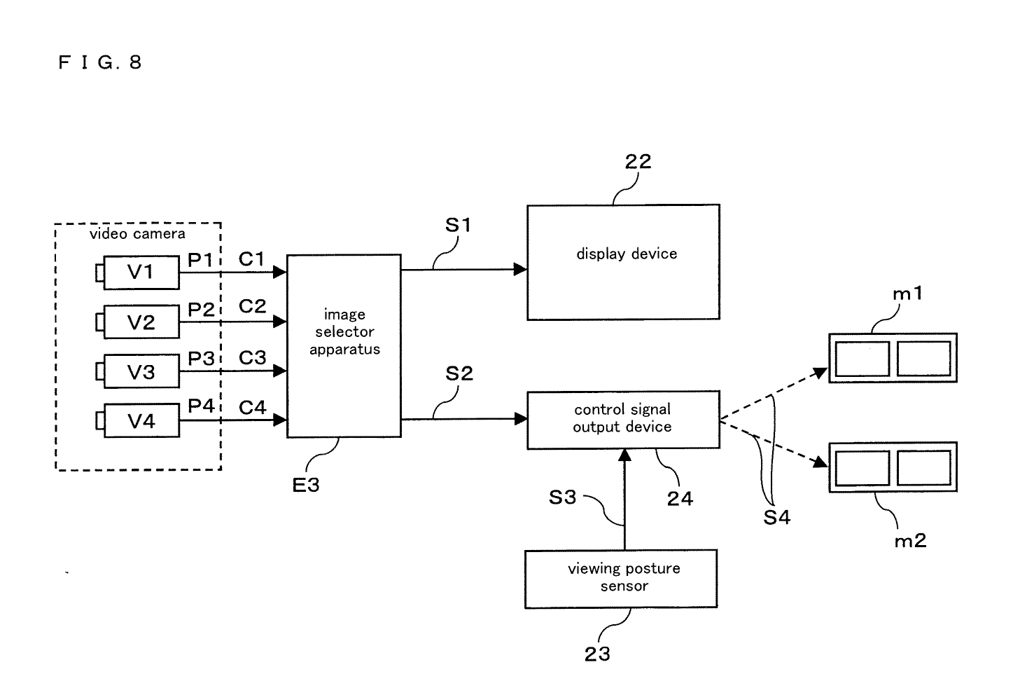

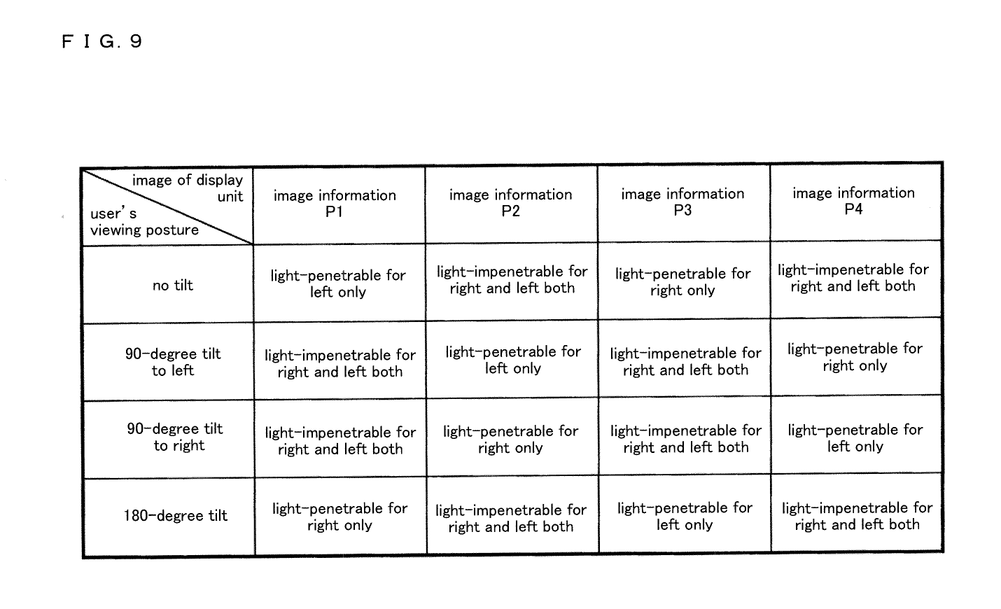

Before starting to describe exemplary embodiments of a 3D image viewing system according to the present invention, basic technical characteristics of a conventional 3D image viewing system are described referring to FIGS. 6-9. FIG. 6 is a perspective view of an image pickup device of a conventional 3D image viewing system. FIG. 7 illustrates in a perspective view an image display device of the conventional 3D image viewing system, devices accessory to the image display device, and examples of a viewer's viewing posture. FIG. 8 is a block diagram illustrating an overall structure of the conventional 3D image viewing system. FIG. 9 is a table illustrating details of a control signal S4 outputted by a control signal output device 24. The system described referring to FIGS. 6-9 has a basic structure of any 3D image viewing system but is not configured according to the exemplary embodiments of the present invention.

As illustrated in FIG. 6, first-fourth video cameras V1, V2, V3, and V4 are provided around a viewfinder 40 and secured to positions equally spaced from one another in upper, lower, right, and left directions. The viewfinder 40 and the four video cameras V1, V2, V3, and V4 are all directed toward a photographic subject 50.

As illustrated in FIG. 7, a first viewer U1 and a second viewer U2 are both seated substantially in front of a display screen of a display device 22. The first viewer U1 wearing first shutter glasses m1 is facing the display screen with no tilt of his head relative to the display screen. The second viewer U2 wearing second shutter glasses m2 is facing the display screen with his head tilting through 90 degrees relative to the display screen. The shutter glasses include liquid crystal glasses having an electronic shutter configured to change the states of penetration units for right and left eyes to and from a light-penetrable state and a light-impenetrable state by controlling a liquid crystal shutter

The display device 22, an example of which is a liquid crystal display, is provided with a viewing posture sensor 23 which detects the viewers' viewing postures by detecting their postures relative to the display device 22 such as a tilt of the shutter glasses m1, m2 worn by the viewer U1, U2, and a control signal output device 24 which controls the shutter glasses m1 and m2.

The shutter glasses m1 and m2 are each provided with a transmission-reception device (not illustrated in the drawings) for measuring the postures of the viewers U1 and U2 relative to the display device 22 through wireless communication with the viewing posture sensor 23.

The control signal S4 outputted from the control signal output device 24 is in charge of a timing control for switching to and from the light-penetrable state and the light-impenetrable state in one or both of the two penetration units in each of the shutter glasses m1 and m2.

As illustrated in FIG. 8, the 3D image viewing system has an image selector apparatus E3, the four video cameras V1-V4, display device 22, viewing posture sensor 23, control signal output device 24, and first and second shutter glasses m1 and m2.

The image selector apparatus E3 selects one of images captured by the four video cameras V1-V4 per frame and outputs the selected image in the form of an image signal S1. The image selector apparatus E3 also outputs a synchronizing signal S2 to the control signal output device 24, the control signal S2 indicating which of image informations P1-P4 obtained by the four video cameras V1-V4 corresponds to the image signal S1 currently outputted. The display device 22 displays an image based on the image signal S1.

The four video cameras V1-V4 and the image selector apparatus E3 are interconnected with independent transmission cables C1-C4. The viewing posture sensor 23 generates a viewing posture information S3 indicating the postures of the first and second viewers U1 and U2 relative to the display screen of the display device 22, such as a tilt of the viewer's head, based on the signal received from the first and second shutter glasses m1 and m2, and then outputs the generated viewing posture information S3 to the control signal output device 24.

The viewing posture information S3 recited in this description includes information that enables to determine whether the head is tilting relative to the screen, more particularly, whether the posture has “no tilt”, “90-degree tilt to left”, “90-degree tilt to right”, or “180-degree tilt”. The direction where the viewer's head is tilting, right or left, indicates the direction where the head is tilting when the viewer is seen from the side of the display device 22. The head of the second viewer U2 tilting to “right” drawn in FIG. 7 is tiling to “left” when seen from the side of the display device 22, in which case the head of the second viewer U2 is tilting to “left” according to the viewing posture information S3.

The control signal output device 24 generates and outputs the control signal S4 for the first and second shutter glasses m1 and m2 both based on the synchronizing signal S2 from the image selector apparatus E3 and the viewing posture information S3 from the viewing posture sensor 23.

The control signal S4 is a signal which controls the timing of switching to and from the light-penetrable state and the light-impenetrable state in the right and left penetration units of the shutter glasses m1 and m2 so that the viewers U1 and U2 can both watch 3D images.

In FIG. 9, details of the control signal S4 outputted from the control signal output device 24 are tabulated. More specifically, the drawing is a correlative table of the four video cameras V1-V4 identified by the synchronizing signal S2 and the postures of the viewers U1 and U2 relative to the display device 22 identified by the viewing posture information S3 (“no tilt”, “90-degree tilt to left”, “90-degree tilt to right”, or “180-degree tilt”), illustrating the timing control for switching to and from the light-penetrable state and the light-impenetrable state in one or both of the right and left penetration units of the shutter glasses m1 and m2.

Next, an operation of the 3D image viewing system is described.

### Example 1

### First Viewer U1

An operation when the first viewer U1 is seated substantially in front of the display device 22 is described. The viewing posture sensor 23 detects the viewing posture of the first viewer U1 from the relative posture of the first shutter glasses m1. Since the first viewer U1 is facing the screen without tilting his head, the viewing posture sensor 23 determines that the viewing posture of the first viewer U1 has “no tilt” and outputs the determined posture as the viewing posture information S3 to the control signal output device 24.

The control signal output device 24 generates the control signal S4 based on the tabulated provisions of FIG. 9 and outputs the generated control signal S4 to the first shutter glasses m1. While the image information P1 of the video camera V1 is being displayed on the display device 22 for the first shutter glasses m1 worn by the first viewer U1 with “no tilt”, the control signal S4 is outputted so that the penetration unit for left eye is made light-penetrable and the penetration unit for right eye is made light-impenetrable. While the image information P3 of the video camera V3 is being displayed on the display device 22, the control signal S4 is outputted so that the penetration unit for right eye is made light-penetrable and the penetration unit for left eye is made light-impenetrable. While the image informations P2 and P4 of the video cameras V2 and V4 are being displayed on the display device 22, the control signal S4 is outputted so that the penetration units for right and left eyes are both made light-impenetrable.

In the first shutter glasses m1 worn by the first viewer U1, a liquid crystal shutter is controlled based on the control signal S4. Therefore, when the first viewer U1 views the display device 22 through the first shutter glasses m1, the image information P1 of the video camera v1 is viewed with his left eye, while the image information P3 of the video camera V3 is viewed with his right eye. The video camera V1 and the video camera V3 are positioned on the left and right sides of the viewfinder 40 as illustrated in FIG. 6, therefore, the image information P1 and the image information P3 constitute a combination of images having parallax information on the right and left sides. When these image informations are viewed with right and left eyes, the first viewer U1 can watch 3D images.

### Example 2

### Second Viewer U2

An operation when the second viewer U2 viewing the display device 22 is lying down is described. The viewing posture sensor 23 detects the viewing posture of the second viewer U2 from the relative posture of the second shutter glasses m2. Since the second viewer U2 is facing the screen with his head tilting through 90 degrees to left (not right) when seen from the side of the display device 22, the viewing posture sensor 23 determines that the viewing posture of the second viewer U2 is “tilting to left through 90 degrees” and outputs the determined posture as the viewing posture information S3 to the control signal output device 24.

The control signal output device 24 generates the control signal S4 based on the tabulated provisions of FIG. 9 and outputs the generated control signal S4 to the second shutter glasses m2. While the image information P2 of the video camera V2 is being displayed on the display device 22 for the second shutter glasses m2 worn by the second viewer U2 “tilting to left through 90 degrees”, the control signal S4 is outputted so that the penetration unit for left eye is made light-penetrable and the penetration unit for right eye is made light-impenetrable. While the image information P4 of the video camera V4 is being displayed on the display device 22, the control signal S4 is outputted so that the penetration unit for right eye is made light-penetrable and the penetration unit for left eye is made light-impenetrable. While the image informations P1 and P3 of the video cameras V1 and V3 are being displayed on the display device 22, the control signal S4 is outputted so that the penetration units for right and left eyes are both made light-impenetrable.

In the second shutter glasses m2 worn by the second viewer U2, a liquid crystal shutters is controlled based on the control signal S4. Therefore, when the second viewer U2 views the display device 22 through the second shutter glasses m2, the image information P2 of the video camera v2 is viewed with his left eye, while the image information P4 of the video camera V4 is viewed with his right eye. The video camera V2 and the video camera V4 are positioned on the upper and lower sides of the viewfinder 40 as illustrated in FIG. 6, therefore, the image information P2 and the image information P4 constitute a combination of images having parallax information on the upper and lower sides. When these image informations are viewed with right and left eyes, the second viewer U2 can watch 3D images. When the second viewer U2 is tilting his head through 90 degrees relative to the display device 22, the right and left directions for him are almost upper and lower directions in an actual space.

So far were described the basic technical characteristics of the conventional 3D image viewing system. The exemplary embodiments of the 3D image viewing system according to the present invention are hereinafter described.

### Exemplary Embodiment 1

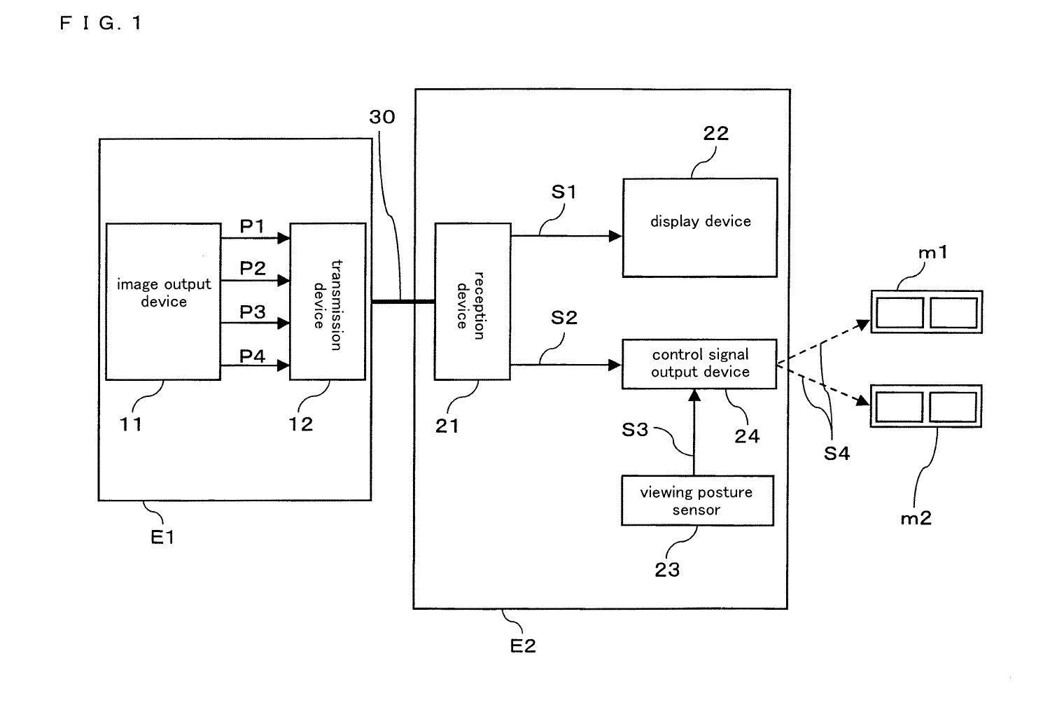

FIG. 1 is a block diagram illustrating an overall structure of a 3D image viewing system according to an exemplary embodiment 1 of the present invention. A reference symbol E1 illustrated in FIG. 1 is a 3D image playback apparatus. The 3D image playback apparatus E1 includes an image output device 11 and a transmission device 12. E2 is a 3D image display apparatus. The 3D image display apparatus E2 includes a reception device 21, a display device 22, a viewing posture sensor 23, and a control signal output device 24. 30 is a transmission cable (HDMI cable). The transmission cable 30 interconnects the transmission device 12 of the 3D image playback apparatus E1 and the reception device 21 of the 3D image display apparatus E2. m1 is first shutter glasses worn by a first viewer U1, and m2 is second shutter glasses worn by a second viewer U2.

P1 is a first image information outputted from the image output device 11, P2 is a second image information outputted from the image output device 11, P3 is a third image information outputted from the image output device 11, and P4 is a fourth image information outputted from the image output device 11.

The image output device 11 of the 3D image playback apparatus E1 records therein the image informations P1-P4 obtained from a plurality of image pickup positions different to one another by four video cameras V1-V4. Further, the image output device 11 associates the image informations P1-P4 respectively with information of their image pickup positions and cyclically outputs the resulting informations in the form of video data in a given order. The image informations P1-P4 are the base image data of 3D images.

The transmission device 12 transmits respective frames of the image informations P1-P4 (including information of image pickup positions) outputted from the image output device 11 in the form of HDMI (High Definition Multimedia Interface) video data through the HDMI cable 30 which is the only transmission cable. The transmission device 12 outputs the image informations P1-P4 using frame rates four times higher than the image informations P1-P4 while cyclically switching to and from the four informations per frame. Further, the transmission device 12 transmits switching notice packets using HDMI VSI packets. The switching notice packet is transmitted synchronously with the output of the first image information P1.

The HDMI was defined as a new standard of high definition interfaces used between digital AV devices. The HDMI is an interface specification developed for next-generation digital televisions that enables to transmit uncompressed high-definition video signals and multi-channel digital audio signals with a very high quality as well as control signals through a transmission cable.

The HDMI VSI (Vendor Specific Info Frames) packet is a packet used to extend information transmitted through HDMI depending on usage. The switching notice packet is a packet used to identify the information of image pickup positions of frames transmitted as the HDMI video data.

In the description of the system, the image informations P1-P4 to be transmitted are not compressed but are transmitted in the form of HDMI video data. However, frame rate thinning, resolution downscaling, interlacing, and progressive conversion may be accordingly performed thereto.

The reception device 21 of the 3D image display apparatus E2 receives the video data and packet data (corresponding to the image informations P1-P4 of a plurality of positions) through the HDMI cable 30 and outputs the received video data in the form of an image signal S1 to the display device 22. The reception device 21 outputs, as well as the image signal S1, a synchronizing signal S2 indicating which of the plurality of positions corresponds to the image signal S1 currently outputted.

The HDMI data transmission is performed in three different periods; video data period, data island period, and control period. During the video data period, pixel data of video signals formatted according to the EIA/CEA-861 (video data) is transmitted. During the data island period, packet data of audio stream signals formatted according to the IEC06958 is transmitted. During the control period or data island period, encoded horizontal synchronizing signals and vertical synchronizing signals are transmitted. The packet data transmitted during the data island period includes packet data generated by encoding 4-bit data into 10-bit data according to the TERC4 (TMDS Error Reducing Coding in 4 bit) encoding technique.

The display device 22 inputs therein the image signal S1 outputted from the reception device 21 and displays an image based on the image signals S1. The viewing posture sensor 23 detects the postures of the shutter glasses m1 and m2 worn by the first and second viewers U1 and U2 such as a tilt relative to the display device 22 and generates a display device viewing posture information S3 (hereinafter, simply called viewing posture information S3, and then outputs the generated information to the control signal output device 24. The posture of the shutter glasses m1, m2 is described below. Conventionally, horizontal and vertical directions of the display device 22 are predefined, and the display device 22 is then placed so that its horizontal direction is in parallel with a floor surface. When the viewer wearing the shutter glasses m1, m2 sits up in a chair and views the display device 22 thus placed, a line which interconnects eye parts of the shutter glasses m1, m2 extends substantially horizontally. At the time, the shutter glasses m1, m2 are taking a posture in parallel with the display device 22. When the viewer wearing the shutter glasses m1, m2 lies down so that the interconnecting line extends substantially vertically relative to view the display device 22, the shutter glasses m1, m2 are taking a posture vertical to the display device 22. Thus, the shutter glasses m1, m2 are positioned through different angles relative to the display device 22 depending on the viewer's viewing posture, and the differently-angled position is called the posture of the shutter glasses m1, m2. The posture of the shutter glasses m1, m2 is very important to make the viewer recognize the 3D image. Therefore, it is necessary to select the image information suitable for the posture and control the shutter glasses m1, m2 (control the penetration units for both eyes to be light-penetrable or light-impenetrable) depending on the selected image information. The present exemplary embodiment provides a device configured to detect the postures of the shutter glasses m1 and m2 (viewing posture sensor 23), thereby making the present invention more available in actual products.

The viewing posture sensor 23 generates the viewing posture information S3 based on the viewer's position (such as tilt of head) and the viewer's viewing direction relative to the display device 22 (viewing angle), thereby displaying 3D images flexibly responding to the viewer's changing viewing angle relative to the display device 22. The viewing direction is the viewer's viewing angle relative to the display device 22, indicating a positional relationship (direction) of the viewer to the display device 22 placed horizontally.

The control signal output device 24 receives the viewing posture information S3 from the viewing posture sensor 23 and the synchronizing signal S1 from the reception device 21, and generates and outputs the control signal S4 for controlling the shutter glasses m1 and m2 depending on the received viewing posture information S3 and synchronizing signal S2.

In the shutter glasses m1 and m2 worn by the first and second viewers U1 and U2, the penetration units for right and left eyes are timing-controlled based on the control signal S4 to switch to and from the light-penetrable state and the light-impenetrable state. The shutter glasses m1 and m2 are each provided with a transmission-reception device (not illustrated in the drawings) for measuring the postures of the viewers U1 and U2 relative to the display device 22 through wireless communication with the viewing posture sensor 23.

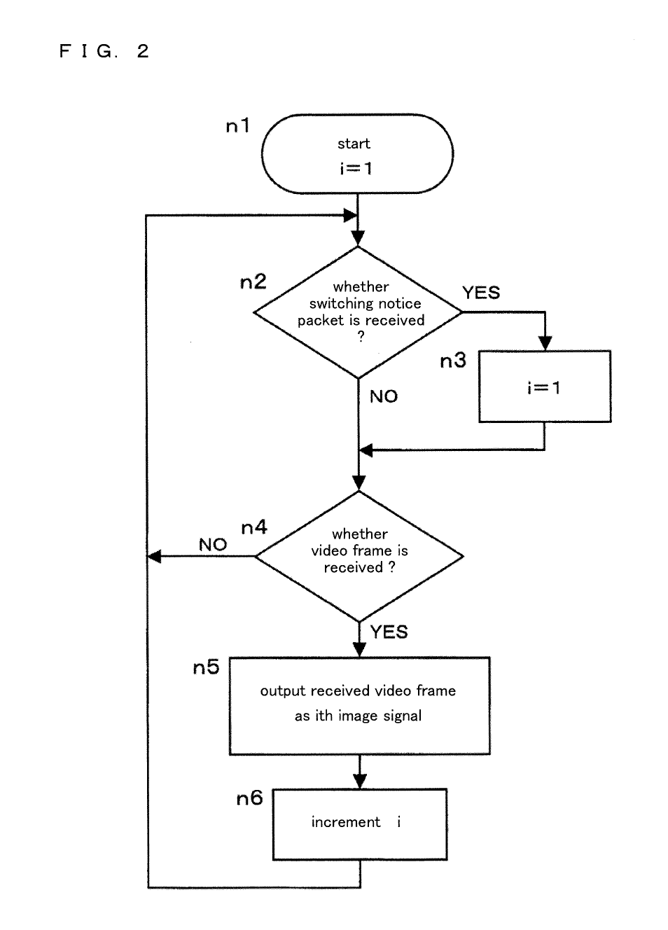

An operation of the reception device 21 of the 3D image display apparatus E2 is described referring to a flow chart illustrated in FIG. 2. In Step n1, the reception device 21 starts to operate and initializes an internal variable i to “1”. In Step n2, the reception device 21 determines whether the switching notice packet indicating the output timing of the first image information P1 is received. When the reception device 21 determines in Step n2 that the switching notice packet was received, the operation proceeds to Step n3. When the reception device 21 determines in Step n2 that the switching notice packet was not received, the operation proceeds to Step n4. The reception device 21 decodes TMDS (Transition Minimized Differential Signaling) transmitted from the transmission device 12 and performs BCH error correction thereto. The reception device 21 also determines whether the VSI packet normally received includes the switching notice packet. The TMDS is encoded according to the TERC4 (TMDS Error Reduction Coding-4). The TMDS is a digital signal transmission method used for data communication with a device such as personal computer, television, and display, and spelled out as transition minimized differential signaling. Step n2 may simply determine whether the VSI packet normally received includes the switching notice packet, in which case it is preferable that the TERC4 decoding and the BCH error correction of the TMDS transmitted from the transmission device 12 be carried out in a different processing step separately from Step n2.

In Step n3 after the reception device 21 determines in Step n2 that the switching notice packet was received, the internal counter i is initialized to “1”, and the operation proceeds to Step S4. In Step n4 subsequent to Step n2 or Step n3, the reception device 21 determines whether a video frame is received. When the reception device 21 determines in Step n4 that the video frame was not received, the operation returns to Step n2. When the reception device 21 determines in Step n4 that the video frame was received, the operation proceeds to Step n5. The reception device 21 determines whether the video frame is received depending on whether TERC4-encoded or control period-encoded VSYNC (vertical synchronizing signal) is detected.

In Step n5, the received video frame is outputted as the ith (i is an internal variable) image signal 51, and outputs the synchronizing signal S2 indicating that the outputted image signal 51 is the image of the ith video camera. In Step n6, the internal variable i is incremented. Then, the operation returns to Step n2.

An operation of the 3D image viewing system according to the present exemplary embodiment is described. The 3D image playback apparatus E1 outputs the image informations P1-P4 of a plurality of positions in the form of HDMI video data through the HDMI cable 30 which is the only transmission cable while cyclically switching to and from the four informations per frame. Every time when the first image information P1 is transmitted, the switching notice packet is transmitted in the data island period. The data island period is a period prior to the transmission of the first image information P1 during which no video data is outputted. The switching notice packet is transmitted with an enough time for the reception device 21 to complete the data reception during the data island period and perform the error correction before the vertical synchronizing signal VSYNC of the first image information P1 is outputted in the control period or the data island period.

Upon detecting that the video data or the packet data starts to be received through the HDMI cable 30 starts, the reception device 21 of the 3D image display apparatus E2 starts data reception steps in accordance with the flow chart illustrated in FIG. 2. The reception device 21 outputs the received video frame as the image signal S1 to the display device 22, thereby cyclically outputting the image informations P1-P4 obtained by the video cameras V1-V4 as the image signal S1. Synchronously with the output of the image signal S1, the reception device 21 outputs the synchronizing signal S2 indicating which of the image informations P1-P4 obtained by the first-fourth video cameras V1-V4 corresponds to the image signal S1 currently outputted to the control signal output device 24. In the case where the reception device 21 receives the video frame but has received no switching notice packet, it cannot be determined which of the image informations P1-P4 corresponds to the video frame. Therefore, it is unnecessary to output the received video frame as the image signal S1.

The control signal output device 24 outputs the control signal S4 by a timing synchronizing with the image signal S1 outputted to the display device 22 based on the viewing posture information S3 from the viewing posture sensor 23 and the synchronizing signal S2 from the reception device 21 for the timing control of the light-penetrable state and the light-impenetrable state in the penetration units for right and left eyes of the shutter glasses m1 and m2 worn by the first and second viewers U1 and U2. Accordingly, the first viewer U1 wearing the first shutter glasses m1 and the second viewer U1 wearing the second shutter glasses m2 can both watch 3D images. The reception device 21 generates the synchronizing signal S2 in response to the detection of the switching notice packet, and the control signal output device 24 generates the control signal S4 based on the synchronizing signal S2, thereby accurately performing the timing-control of the light-penetrable state and the light-impenetrable state in the shutter glasses m1 and m2. The rest of the operation, which is similar to the basic technical characteristics of the conventional 3D image viewing system illustrated in FIGS. 6-9, is not described.

In the 3D image viewing system according to the present exemplary embodiment, the 3D image playback apparatus E1 and the 3D image display apparatus E2 are interconnected with the HDMI cable 30 which is the only transmission cable. This significantly simplifies and facilitates a wiring arrangement as compared to the system described referring to FIGS. 6-9, wherein it is necessary to route different wirings from a plurality of video cameras.

The 3D image viewing system is further technically advantageous in that the HDMI-compliant image data can be directly transmitted and received, and the existing HDMI-compliant data island packet can be extended and used to transmit the positional information. To produce the 3D image playback apparatus E1 and the 3D image display apparatus E2 for practical use, therefore, any HDMI-compliant transmission devices and reception devices currently available can be directly used with minimum circuit redesign.

There are other advantages; only the truly necessary information can be selected from a plurality of image informations and then transmitted, which helps to increase an image display frame rate, and the data to be transmitted through the transmission cable is narrowed down based on the viewing posture information S3, which improves a transmission efficiency of the transmission cable. As a result, the video data including a plurality of different image informations can be efficiently transmitted through the only transmission cable. Then, 3D images can be displayed as expected regardless of whether the posture of the viewer wearing the shutter glasses m1, m2 is off balance.

The video data stores therein the image informations in a predefined cyclic order, and further includes the switching notice packet indicating that a switching cycle of the plurality of image informations is over. Therefore, the light penetration timing control in the shutter glasses m1 and m2 can be very accurate.

### Exemplary Embodiment 2

An exemplary embodiment 2 of the present invention is technically characterized in that any of the plurality of image informations P1-P4 previously determined as unnecessary based on the posture of the viewer U1, U2 relative to the display device 22 is selectively not transmitted from the 3D image playback apparatus E1 to the 3D image display apparatus E2. According to the exemplary embodiment 2, therefore, the viewing posture information S3 from the viewing posture sensor 23 in the 3D image display apparatus E2 is transmitted to the 3D image playback apparatus E1 so that any image information known as unnecessary based on the viewing posture information S3 received by the 3D image playback apparatus E1 is excluded from candidates to be selected, and any image information necessary is selectively transmitted. Simply describing a system according to the present exemplary embodiment, it is configured as a view posture sensitive system capable of removing any unnecessary image information not to be displayed. The object of the technical feature is to improve the transmission efficiency of the HDMI cable 30 which is the only transmission cable so that the image display frame rate is improved.

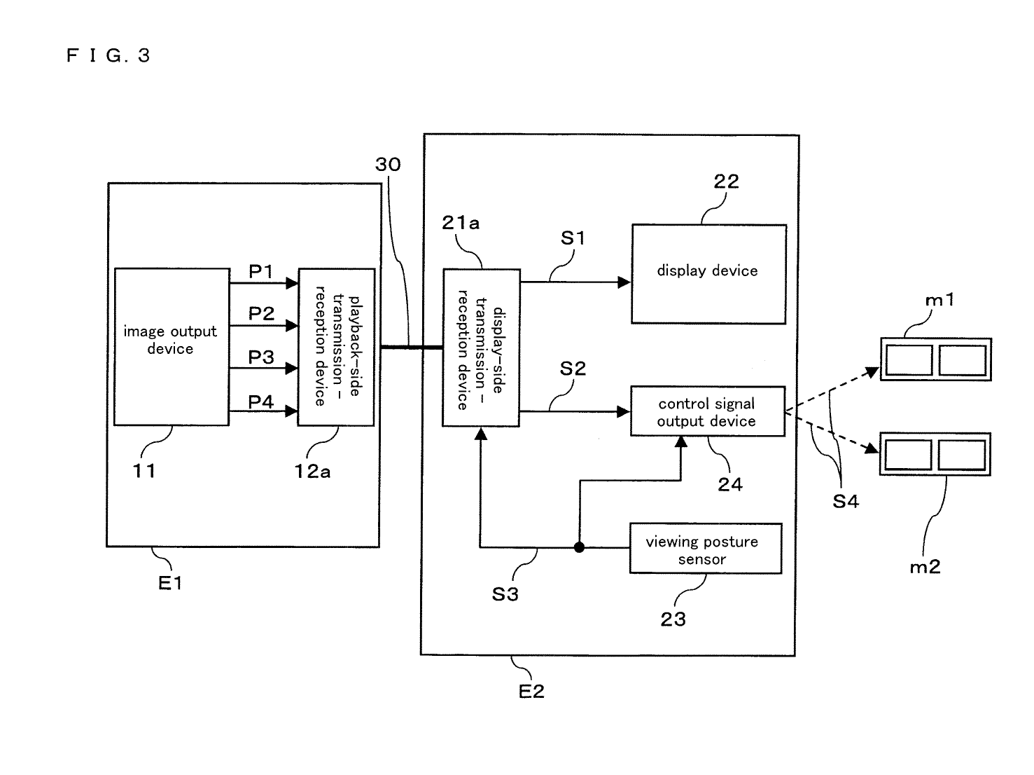

FIG. 3 is a block diagram illustrating an overall structure of a 3D image viewing system according to the exemplary embodiment 2. Any reference symbols of FIG. 3 similar to those illustrated in FIG. 1 according to the exemplary embodiment 1 denote the same structural elements, therefore, will not be described.

A 3D image playback apparatus E1 according to the present exemplary embodiment is provided with a playback-side transmission-reception device 12a in place of the transmission device 12 according to the exemplary embodiment 1. A 3D image display apparatus E2 according to the present exemplary embodiment is provided with a display-side transmission-reception device 21a in place of the reception device 21 according to the exemplary embodiment 1. The playback-side transmission-reception device 12a of the 3D image playback apparatus E1 and the display-side transmission-reception device 21a of the 3D image display apparatus E2 are interconnected with a HDMI cable 30 which is the only transmission cable to enable bidirectional transmission.

A viewing posture sensor 23 of the 3D image display apparatus E2 outputs the generated viewing posture information S3 to the display-side transmission-reception device 21a.

The display-side transmission-reception device 21a of the 3D image display apparatus E2 is configured to transmit the viewing posture information S3 inputted from the viewing posture sensor 23 to the playback-side transmission-reception device 12a of the 3D image playback apparatus E1 through the HDMI cable 30 which is the only transmission cable in addition to the features of the reception device 21 according to the exemplary embodiment 1. The display-side transmission-reception device 21a outputs the viewing posture information S3 to the playback-side transmission-reception device 12a using HDMI-CEC (Consumer Electronic Control).

In addition to the features of the transmission device 12 according to the exemplary embodiment 1, the playback-side transmission-reception device 12a of the 3D image playback apparatus E1, based on the viewing posture information S3 received from the 3D image display apparatus E2, is configured to:
select at least one of image informations of respective frames (hereinafter, called frame informations) in the image informations P1-P4 (obtained from different image pickup positions) inputted from the image output device 11;
output the selected frame information per frame as the HDMI video data; and
transmit the switching notice packet using the VSI packet synchronously with the output timing of the video data.

More specifically, the playback-side transmission-reception device 12a is configured to:
select from the image informations P1-P4 obtained from a plurality of positions an image signal for right eye and an image signal for left eye for the first shutter glasses m1 worn by the first viewer U1 based on the viewing posture information S3;
output the selected image signals for right and left eyes as the first and second image informations (HDMI video data);
select from the image informations P1-P4 obtained from a plurality of positions an image signal for right eye and an image signal for left eye for the second shutter glasses m2 worn by the second viewer U2 based on the viewing posture information S3; and
output the selected image signals for right and left eyes as the third and fourth image informations (HDMI video data).

The image information is thus selected based on the viewing posture information S3 so as to display 3D images most suitable for the viewing postures of the viewers U1 and U2 who are watching the display device 22. A timing by which the playback-side transmission-reception device 12a transmits the switching notice packet is equal to a timing of outputting the first image information.

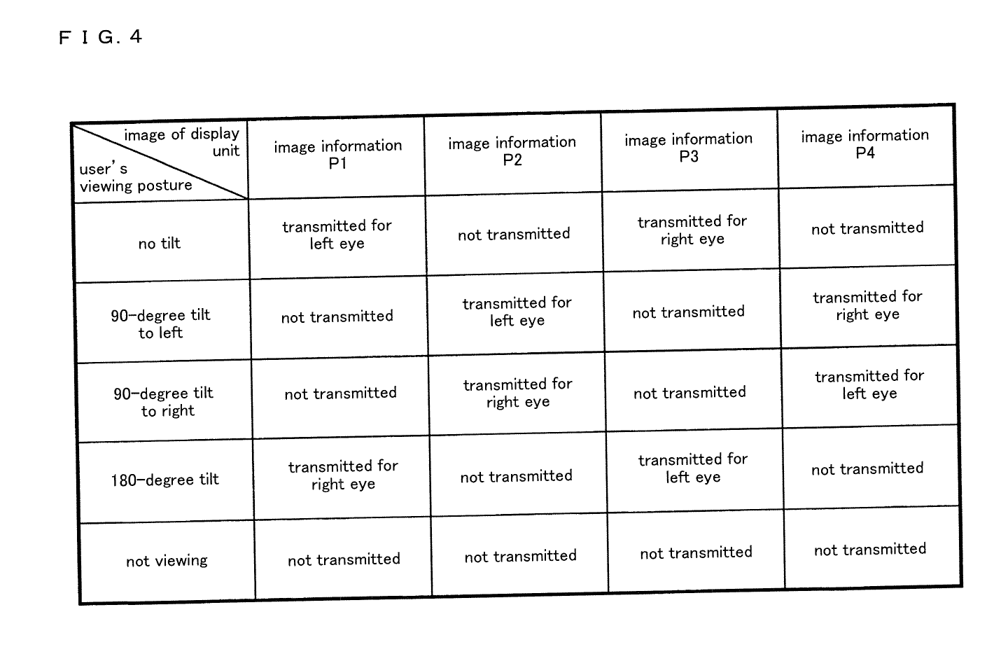

FIG. 4 is a correlative table of the viewing posture information S3 and the image informations P1-P4 of a plurality of positions, illustrating how the control signal S4 inputted to the shutter glasses m1 and m2 is defined.

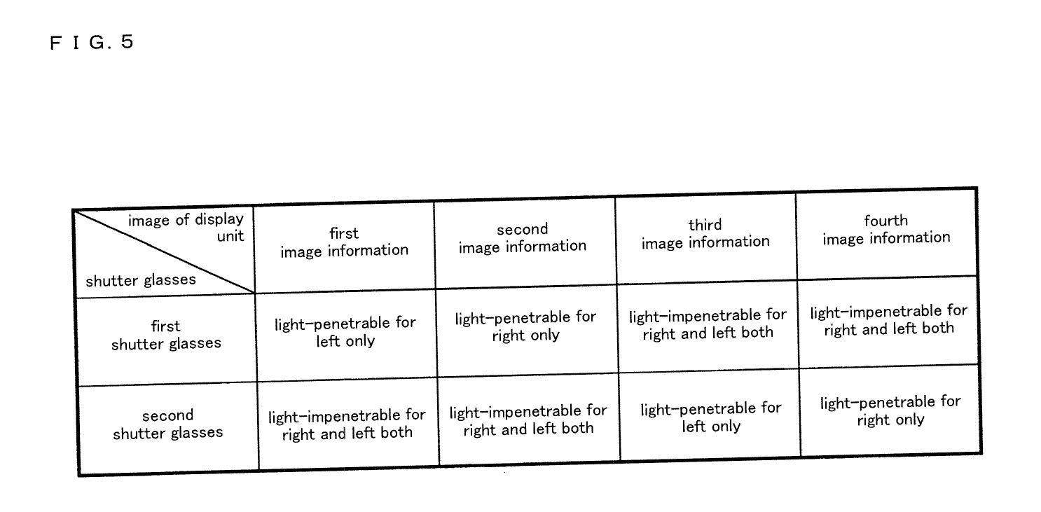

FIG. 5 is a correlative table of the viewing posture information S3 indicating the viewing postures of the viewers U1 and U2 and the image informations to be suitably selected for the respective postures in the playback-side transmission-reception device 12a. The rest of the technical characteristics are similar to exemplary embodiment, therefore, will not be described.

An operation of the 3D image viewing system according to the present exemplary embodiment is described. The operation described below is performed in the case where, for example, the first viewer U1 is watching the display device 22 with a tilt to right through 90 degrees relative to the display device 22, and the second viewer U2 is watching the display device 22 with a tilt to left through 90 degrees relative to the display device 22. It is to be noted that the directions of the respective tilts, right and left, describe the tilts of the viewers U1 and U2 when seen from the side of the display device 22. When the description says that the first viewer U1 is tilting to right through 90 degrees relative to the display device 22, the first viewer U1 is tilting to left on the drawing of FIG. 7. When the description says that the second viewer U2 is tilting to left through 90 degrees relative to the display device 22, the second viewer U2 is tilting to right on the drawing of FIG. 7. Thus, the directions of the respective tilts of the viewers U1 and U2 are opposite to the positional relationship drawn in FIG. 7.

The first shutter glasses m1 worn by the first viewer U1 tilting to right through 90 degrees relative to the display device 22 needs; the image information P4 taken by the fourth video camera V4 in its penetration unit for left eye, and the image information P2 taken by the second video camera V2 in its penetration unit for right eye.

The second shutter glasses m2 worn by the second viewer U2 tilting to left through 90 degrees relative to the display device 22 needs; the image information P2 taken by the second video camera V2 in its penetration unit for left eye, and the image information P4 taken by the fourth video camera V4 in its penetration unit for right eye.

This means that neither of the first glasses m1 nor the second shutter glasses m2 needs the display of the image information P3 taken by the third video camera V3 or the image information P4 taken by the fourth video camera V4. Therefore, when the viewing posture information S3 is transmitted from the viewing posture sensor 23 of the 3D image display apparatus E2 to the display-side transmission-reception device 21a, and the viewing posture information S3 is inputted to the playback-side transmission-reception device 12a of the 3D image playback apparatus E1 through the HDMI cable 30, the playback-side transmission-reception device 12a selects the second image information P2 and the fourth image information P4 determined as necessary based on the viewing posture information S3 from all of the four image informations P1-P4 inputted from the image output device 11, and rules out the first image information P1 and the third image information P3 determined as unnecessary based on the viewing posture information S3 from the candidates to be selected. Below is given a more detailed description.

The viewing postures of the first and second viewers U1 and U2 are detected by the viewing posture sensor 23 in the 3D image display apparatus E2, and the viewing posture information S3 is outputted to the display-side transmission-reception device 21a. Further, the viewing posture information S3 is transmitted to the playback-side transmission-reception device 12a of the 3D image playback apparatus E1 through the HDMI cable 30 which is the only communication cable.

As described earlier, the first viewer U1 is taking the viewing posture tilting to right through 90 degrees relative to the display device 22. It is known from the table illustrated in FIG. 4 that, in the case of the posture tilting to right through 90 degrees, the image information P4 taken by the fourth video camera V4 should be inputted as an image signal for left eye, and the image information P2 taken by the second video camera V2 should be inputted as an image signal for right eye. The second viewer U2 is taking the viewing posture tilting to left through 90 degrees relative to the display device 22. It is known from the table illustrated in FIG. 4 that, in the case of the posture tilting to left through 90 degrees, the image information P2 taken by the second video camera V2 should be inputted as an image signal for left eye, and the image information P4 taken by the fourth video camera V4 should be inputted as an image signal for right eye. According to the table, the image information P1 taken by the first video camera V1 is not transmitted whenever the viewing posture is tilted through 90 degrees regardless of the direction, right or left, and the image information P3 taken by the third video camera V3 is not transmitted whenever the viewing posture is tilted through 90 degrees regardless of the direction, right or left.

Therefore, the playback-side transmission-reception device 12a of the 3D image playback apparatus E1 which received the viewing posture information S3 selects the fourth image information P4 as the image signal for left eye for the first shutter glasses m1 worn by the first viewer U1, while selecting the second image information P2 as the image signal for right eye for the first shutter glasses m1. Further, the transmission-reception device 12a selects the second image information P2 as the image signal for left eye for the second shutter glasses m2 worn by the second viewer U2, while selecting the fourth image information P4 as the image signal for right eye for the second shutter glasses m2. The image informations P4, P2, P2 and P4 are, in the mentioned order, the first image information, second image information, third image information, and fourth image information. The transmission-reception device 12a then transmits these image informations P4, P2, P2 and P4 as the HDMI video data repeatedly to the transmission-reception device 21a of the 3D image display apparatus E2 through the HDMI cable 30. In the data transmission described above, the image information P1 taken by the first video camera V1 and the image information P3 taken by the third video camera V are not transmitted from the play-back transmission-reception device 12a.

The switching notice packet is transmitted during the data island period which is a video data non-output period prior to the output of the first image information, which is the image signal for left eye of the first shutter glasses m1, as the video data. When the switching notice packet is transmitted, packet transmission intervals should be set so that the display-side transmission-reception device 21a can complete the data reception during the data island period and the display device is thereby given an enough time for the error correction before the output of the vertical synchronizing signal VSYNC of the image signal for left eye of the first shutter glasses m1 during the control period or the data island period.

Upon detecting the start of the video data or packet data reception through the HDMI cable 30, the display-side transmission-reception device 21a of the 3D image display apparatus E2 starts to perform data reception steps as illustrated in the flow chart of FIG. 2. The display-side transmission-reception device 21a outputs the received video data in the form of the image signal S1, and further outputs the synchronizing signal S2 synchronously with the output of the image signal S1. The synchronizing signal S2 is a signal indicating which of the first-fourth image informations corresponds to the image signal S1 currently outputted. In the case where the display-side transmission-reception device 21a receives the video frame but has received no switching notice packet, it cannot be determined which of the image informations P1-P4 corresponds to the video frame. Therefore, it is unnecessary to output the received video frame as the image signal S1.

As illustrated in FIG. 5, while the first image information (image signal for left eye of the first shutter glasses m1 worn by the first viewer U1) is being displayed on the display device 22, the control signal output device 24 makes:
the penetration unit for left eye of the first shutter glasses m1 light-penetrable; and
any penetration units but the penetration unit for left eye of the first shutter glasses m1 (penetration unit for right eye of the first shutter glasses m1, and penetration units for right and left eyes of the second shutter glasses m2) light-impenetrable.

While the second image information (image signal for right eye of the first shutter glasses m1) is being displayed on the display device 22, the control signal output device 24 makes:
the penetration unit for right eye of the first shutter glasses m1 light-penetrable; and
any penetration units but the penetration unit for right eye of the first shutter glasses m1 (penetration unit for left eye of the first shutter glasses m1, and penetration units for right and left eyes of the second shutter glasses m2) light-impenetrable.

While the third image information (image signal for left eye of the second shutter glasses m2 worn by the second viewer U2) is being displayed on the display device 22, the control signal output device 24 makes:
the penetration unit for left eye of the second shutter glasses m2 light-penetrable; and
any penetration units but the penetration unit for left eye of the second shutter glasses m2 (penetration unit for right eye of the second shutter glasses m2, and penetration units for right and left eyes of the first shutter glasses m1) light-impenetrable.

While the fourth image information (image signal for right eye of the second shutter glasses m2 worn by the second viewer U2) is being displayed on the display device 22, the control signal output device 24 makes:
the penetration unit for right eye of the second shutter glasses m2 light-penetrable; and
any penetration units but the penetration unit for right eye of the second shutter glasses m2 (penetration unit for left eye of the second shutter glasses m2, and penetration units for right and left eyes of the first shutter glasses m1) light-impenetrable.

As a result of these processing steps, the image informations selected by the playback-side transmission-reception device 12a for a plurality of viewers can be correctly visually recognized as 3D images by the first and second viewers U1 and U2 properly wearing the shutter glasses m1 and m2.

The present exemplary embodiment can improve the transmission efficiency of the HDMI cable 30 which is the only transmission cable, thereby increasing the image display frame rate.

In the description of the present exemplary embodiment, there are two viewers. In the case where there is a third viewer in addition to the two viewers, the playback-side transmission-reception device 12a transmits fifth and sixth image informations, and the control signal output device 24 makes penetration units for right and left eye of shutter glasses worn by the third viewer light-penetrable while the fifth and sixth image information are being displayed. In the case of at least four viewers, the image information to be inputted are increased likewise for shutter glasses worn by more viewers.

The exemplary embodiments 1 and 2 both described the image viewing system wherein the images taken by four video cameras are used, however, the present invention does not necessarily limit the number or location of video cameras. Further, the image viewing system according to the present invention is applicable to images of computer graphics based on 3D data as well as the images taken by video cameras. In such a case, for example, the video cameras are replaced with home video game machines capable of rendering images of computer graphics through a plurality of angles at the same time based on 3D model.

According to the exemplary embodiments 1 and 2, the first and second viewers U1 and U2 who are watching the display unit 22 are seated substantially in front of the display device 22. A plurality of image pickup units each including a plurality of video cameras may be provided at a plurality of different positions relative to a photographic subject so that 3D images can be displayed at any positions regardless of how the viewer's position relative to the display unit 22 changes. The suggested structure is suitable for such a structural characteristic as disclosed in the Patent Document 1 wherein a viewer can watch 3D images regardless of his positional relationship with a display device horizontally placed (regular position, position opposite to the regular position, or positions on lateral sides of the regular position).

In the case of such a system, the control signal output device 24 is preferably configured to output the control signal depending on the viewer's viewing angle relative to the display device 22 other than the tilt of his head, so that the system can flexibly respond to any change of the viewer's viewing angle relative to the display device. The playback-side transmission-reception device 12a is preferably configured not to transmit any images viewable by none of the viewers because their shutter glasses are both light-impenetrable due to the control signal S4 outputted from the control signal output device 24 to the 3D image display apparatus E2 in accordance with the viewing posture information S3 from the viewing posture sensor 23. Accordingly, 3D images can be simultaneously viewed at a large number of viewing positions.

As described so far, the present exemplary embodiment can selectively transmit only the necessary image information among a plurality of image informations based on the viewing posture information S3, thereby increasing the image display frame rate. Further, the present exemplary embodiment narrows down the data to be transmitted through the transmission cable, thereby improving the transmission efficiency of the transmission cable. As a result, the video data including a plurality of different image informations can be efficiently transmitted through only one transmission cable. As well as these advantages, the present exemplary embodiment naturally enables 3D display as expected regardless of any tilt of the viewer wearing the shutter glasses m1, m2.

### INDUSTRIAL APPLICABILITY

The present invention provides an advantageous technology for 3D image viewing in, for example, home theaters, and 3D image display apparatuses, 3D image playback apparatuses, and 3D image viewing system applicable to home-use game machines in which computer graphics is used.

When the data island packet is extended and used to transmit the information of image pickup positions, any HDMI-compliant transmission devices and reception devices currently available can be directly used with minimum circuit redesign to obtain the 3D image playback apparatus.

### DESCRIPTION OF REFERENCE SYMBOLS

C1-C4 transmission cable
E1 3D image playback apparatus
E2 3D image display apparatus
E3 image selector apparatus
m1 first shutter glasses (liquid crystal glasses)
m2 second shutter glasses (liquid crystal glasses)
n1-n6 processing steps by reception device
P1-P4 first-fourth image informations
S1 image signal
S2 synchronizing signal
S3 viewing posture information
S4 control signal
U1 first viewer
U2 second viewer
V1-V4 first-fourth video cameras
11 image output device
12 transmission device
12a playback-side transmission-reception device
21 reception device
21a display-side transmission-reception device
22 display device
23 viewing posture sensor
24 control signal output device
30 HDMI cable
40 viewfinder of image pickup device
50 photographic subject

1. A 3D image display apparatus comprising:
a transmission-reception device configured to receive a video data including a plurality of image informations which is base data of 3D images from a 3D image playback apparatus through a transmission cable and generate an image signal based on the video data;
a display device configured to display thereon an image obtained from the image signal; and
a control signal output device configured to output a control signal to shutter glasses worn by a viewer of the display device, the control signal controlling light-penetration states in penetration units for right and left eyes provided in the shutter glasses, wherein
the transmission-reception device receives the video data from the 3D image playback apparatus through the single transmission cable and generates the image signal and a synchronizing signal based on the received video data, the synchronizing signal indicating which of the plurality of image informations is included in the image signal currently outputted, and
the control signal output device generates the control signal based on the synchronizing signal.

2. The 3D image display apparatus as claimed in claim 1, further comprising a viewing posture sensor configured to detect a posture of the shutter glasses relative to the display device and generate a display device viewing posture information of the viewer based on the detected posture, wherein
the control signal output device generates the control signal based on the display device viewing posture information and the synchronizing signal.

3. The 3D image display apparatus as claimed in claim 2, wherein
the viewing posture sensor further detects a direction of the shutter glasses relative to the display device and generates the display device viewing posture information based on the detected direction and the detected posture.

4. The 3D image display apparatus as claimed in claim 2, wherein
the transmission-reception device transmits the display device viewing posture information to the 3D image playback apparatus through the transmission cable,
the 3D image playback apparatus selects the image information most suitable for the posture of the viewer viewing the display device based on the display device viewing posture information, and generates the video data including the most suitable image information and transmits the generated video data to the 3D image display apparatus through the transmission cable, and
the transmission-reception device receives the video data through the transmission cable.

5. The 3D image display apparatus as claimed in claim 1, wherein
the video data stores therein the image informations cyclically changed in a give order and further includes a switching notice packet indicating that a switching cycle of the plurality of image informations is over, and
the transmission-reception device generates the synchronizing signal based on the switching notice packet.

6. The 3D image display apparatus as claimed in claim 1, wherein
the control signal controls the light-penetration states of the penetration unit for right eye and the penetration unit for left eye of the shutter glasses independently from each other.

7. (canceled)

8. A 3D image playback apparatus, comprising:
an image output device configured to generate a video data including a plurality of image informations which is base data of 3D images and information of image pickup positions indicating positions of the image informations so that the video data and the information of image pickup positions are associated with each other; and
a transmission-reception device configured to transmit the video data and the information of image pickup positions to a 3D image display apparatus through a transmission cable,
wherein
the transmission-reception device receives a display device viewing posture information on a posture of a viewer viewing the 3D image display apparatus from the 3D image display apparatus, and
the transmission-reception device selects the image information most suitable for the posture of the viewer viewing the 3D image display apparatus based on the display device viewing posture information, and generates the video data including the most suitable image information and transmits the generated video data to the 3D image display apparatus through the transmission cable.

9. A 3D image playback apparatus, comprising:
an image output device configured to generate a video data including a plurality of image informations which is base data of 3D images and information of image pickup positions indicating positions of the image informations so that the video data and the information of image pickup positions are associated with each other; and
a transmission-reception device configured to transmit the video data and the information of image pickup positions to a 3D image display apparatus through a transmission cable,
wherein
the video data stores therein the image informations cyclically changed in a give order and further includes a switching notice packet indicating that a switching cycle of the plurality of image informations is over.

10. A 3D image viewing system, comprising:
the 3D image playback apparatus as claimed in claim 8; and
the 3D image display apparatus as claimed in claim 1, wherein
the 3D image playback apparatus and the 3D image display apparatus are interconnected with a transmission cable.

11. A 3D image viewing system, comprising:
the 3D image playback apparatus as claimed in claim 9; and
the 3D image display apparatus as claimed in claim 1, wherein
the 3D image playback apparatus and the 3D image display apparatus are interconnected with a transmission cable.
